(19) United States
(12) Patent Application Publication
(10) Pub. No.: US 2010/0164961 A1
(43) Pub. Date: Jul. 1, 2010

(54) COMMUNICATION SYSTEM, APPARATUS, AND METHOD

(75) Inventors: Takefumi HORIE, Kawasaki (JP); Takayuki Yamaji, Kawasaki (JP); Kazutoshi Sakaguchi, Kawasaki (JP); Kotaro Teranishi, Kawasaki (JP); Makoto Morioka, Kawasaki (JP); Takashi Hirano, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/639,134

(22) Filed: Dec. 16, 2009

(30) Foreign Application Priority Data
Dec. 26, 2008 (JP) 2008-334417

(51) Int. Cl. G06T 1/00

(52) U.S. Cl. 345/501

(57) ABSTRACT

A communication apparatus for communicating with a storage unit and portable display apparatus, the communication apparatus includes, a receiver for receiving an identification information from the portable display apparatus when the portable display apparatus is placed upon the board, an acquisition unit for acquiring from the storage unit the information related to the identification information which is received from the portable display apparatus, and a transmitter for transmitting to the portable display apparatus the information which is acquired by the acquisition unit.

### CROSS-REFERENCE TO RELATED APPLICATIONS

This application is based upon and claims the benefit of priority of the prior Japanese Patent Application No. 2008-334417, filed on Dec. 26, 2008, the entire contents of which are incorporated herein by reference.

### FIELD

The embodiments discussed here are related to communication system, apparatus, and method.

### BACKGROUND

Recently, with the development of cell phones and Wi-Fi (Wireless Fidelity), information provision such as information communications and information retrieval has advanced greatly. For example, there is a technique for extending a display screen by connecting two display apparatuses (e.g., Japanese Patent Laid-Open No. 2004-205933). Also, there is a technique for two-way communications between a displayed poster and cell phone (e.g., Japanese Patent Laid-Open No. 2004-138765). Also, there is a technique for causing a mobile body or robot to display various facial expressions and designs by applying flexibility of a flexible display to a casing skin of a robot (e.g., Japanese Patent Laid-Open No. 2008-149442).

However, with increases in the number of double-income households and in the penetration rates of cell phones and personal computers among home users, reduced communication among family members has become an issue. Also, large amounts of information have become available with the development of cell phones, personal computers, and installed application programs, but this raises the problem of an increase in the complexity of their operation. Consequently, there arises a problem: namely, those who cannot keep pace with the evolution and development of technology are left behind and unable to communicate with those who can.

### SUMMARY

According to an aspect of the invention, an apparatus includes a board, a storage unit for storing information, a portable display apparatus comprising a memory for storing identification information, a first transmitter for transmitting information, first receiver for receiving information, a display unit for displaying information, the portable display apparatus having portability such that the board allows the portable display apparatus to be placed at an arbitrary position upon the board, and a housing, and a communication apparatus comprising a second receiver for receiving the identification information from the portable display apparatus when the portable display apparatus is placed upon the board, an acquisition unit for acquiring from the storage unit the information related to the identification information which is received from the portable display apparatus, and a second transmitter for transmitting to the portable display apparatus the information which is acquired by the acquisition unit. The portable display apparatus, when placed on the board, receives the information acquired by the acquisition unit from the second information by the first receiver, and displays the acquired information on the portable display apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram outlining information provision according to a first example;

FIG. 2 is a perspective view illustrating an external appearance of a memo device according to the first example;

FIG. 3 is a system block diagram of information providing system according to the first example;

FIG. 4 is a block diagram illustrating a hardware configuration of a home server according to the first example;

FIG. 5 is a block diagram illustrating a hardware configuration of the memo device according to the first example;

FIG. 6 is a block diagram illustrating a hardware configuration of a communications device according to the first example;

FIG. 7 is an explanatory diagram illustrating a data structure of an attribute information table according to the first example;

FIG. 8 is an explanatory diagram illustrating a data structure of an output information table according to the first example;

FIG. 9 is a sequence diagram illustrating information providing procedures according to the first example;

FIGS. 10A and 10B are explanatory diagrams illustrating an example of how information is displayed on a memo device according to a second example;

FIG. 11 is a sequence diagram illustrating information providing procedures according to the second example;

FIGS. 12A and 12B are explanatory diagrams illustrating a memo device whose attribute is Weather;

FIGS. 13A to 13C are explanatory diagrams illustrating an example of how a memo device according to a third example is used;

FIG. 14 is a sequence diagram illustrating information providing procedures according to the third example;

FIGS. 15A to 15C are explanatory diagrams illustrating an example of how a display area is extended, according to a fourth example;

FIG. 16 is an explanatory diagram illustrating a data structure of an attribute information table according to the fourth example;

FIG. 17 is an explanatory diagram illustrating a data structure of a common image information table;

FIG. 18 is a sequence diagram (Part 1) illustrating information providing procedures according to the fourth example;

FIG. 19 is a sequence diagram (Part 2) illustrating the information providing procedures according to the fourth example;

FIG. 20 is a plan view of a board according to a fifth example;

FIG. 21 is a perspective view of the board according to the fifth example;

FIG. 22 is a perspective view illustrating an external appearance of a memo device when viewed from behind;

FIG. 23 is a block diagram illustrating a hardware configuration of a communications device according to the fifth example;

FIG. 24 is an explanatory diagram illustrating an example of how a memo device whose attribute is Weather is attached, according to the fifth example;

FIG. 25 is an explanatory diagram illustrating a coordinate table;

FIG. 26 is a sequence diagram illustrating information providing procedures according to the fifth example;

FIG. 27 is an explanatory diagram illustrating a biomedical sensor;

FIGS. 28A to 28E are explanatory diagrams illustrating analysis results of physical conditions displayed on the memo device;

FIG. 29 is an explanatory diagram illustrating a usage scene (Part 1) in an office;

FIG. 30 is an explanatory diagram illustrating a usage scene (Part 2) in an office; and

FIG. 31 is an explanatory diagram illustrating a usage scene (Part 3) in an office.

### BRIEF DESCRIPTION OF EMBODIMENTS

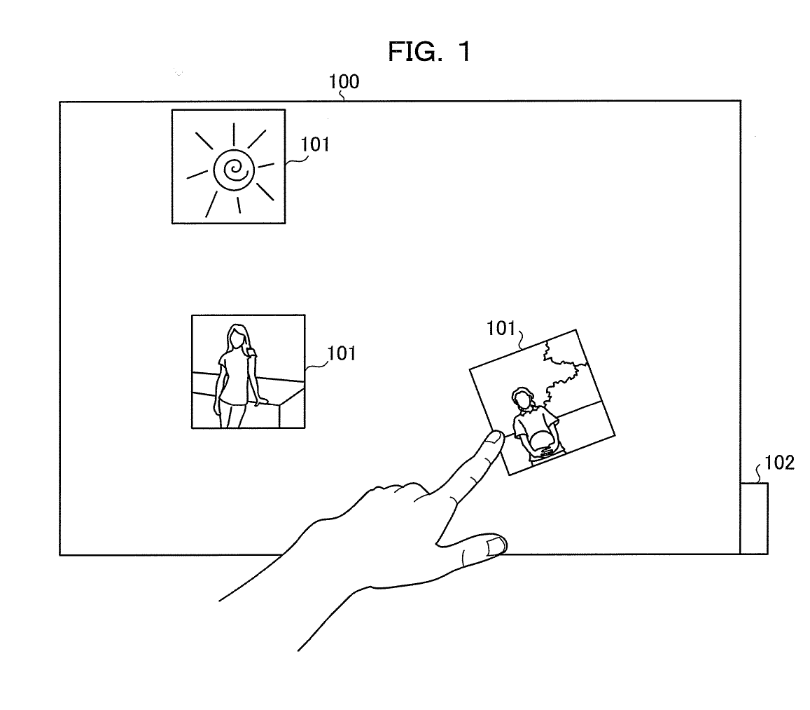

FIG. 1 is an explanatory diagram outlining information provision according to the present embodiment. Information provision according to the present embodiment involves attaching display apparatuses called memo devices 101 and equipped with a magnet to a metal board 100 such as a white board, as in the case of stickers, and displaying unique information such as image data and character string data on a display screen of each memo device 101. For example, weather forecasts, image data of individuals, character string data, and/or icons are displayed.

The memo device 101 is configured to be capable of Bluetooth (registered trademark), RFID (Radio Frequency IDentification), or other contactless communications with a communications device 102 of the board 100. Information can also be written on the board 100 using a marker as in the case of an existing white board.

The contactless communications between the memo device 101 and communications device 102 may be configured to be conducted only when the memo device 101 is attached to the board 100. Specifically, for example, a push switch may be installed on the rear face of the memo device 101 to permit communications with the communications device 102 when the memo device 101 is attached to the board 100, pressing the push switch.

(External Appearance of the Memo Device 101)

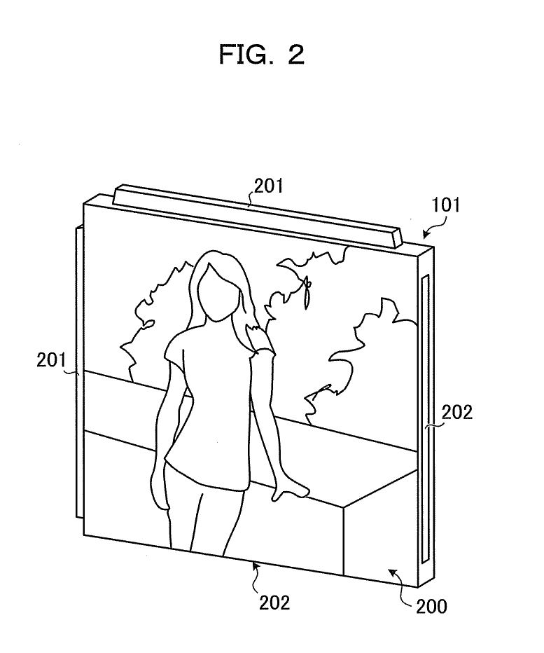

FIG. 2 is perspective views illustrating an external appearance of the memo device 101 according to the embodiment. A display device such as electronic paper is installed on a surface of the memo device 101 to provide a display screen 200. Also, a male connectors 201 are installed on an upper end face and left end face while female connectors 202 are installed on a lower face and right end face. Similarly, an extended screen with a landscape display area results upon the male connector 201 on the left end face of one memo device 101 is connected to the female connector 202 on the right end face of another memo device 101.

Similarly, an extended screen with a portrait display area results upon the male connector 201 on the upper end face of one memo device 101 is connected to the female connector 202 on the lower end face of another memo device 101. Also, connecting two memo devices 101 enables their intercommunications. In that case, the male connector 201 and female connector 202 may be convex-shaped.

(System Configuration of Information Providing System)

Next, description will be given of a system configuration of information providing system which includes the memo devices 101 and board 100. The information providing system is used at homes and offices.

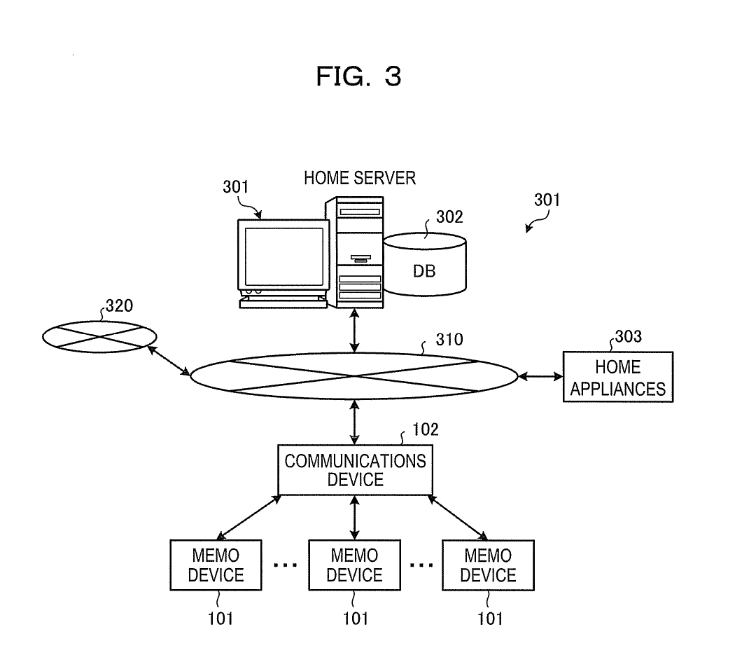

FIG. 3 is a system block diagram of the information providing system according to the present embodiment. In FIG. 3, the information providing system 300 includes a home server 301, a communications device 102, and home appliances 303, all of which are interconnected via a LAN (Local Area Network) 310, being ready to communicate with one another. Also, as described above, the communications device 102 and memo devices 101 conduct contactless communications. Besides, the home server 301 is connected to an external network 320 such as the Internet via the LAN 310 in a communication-ready state.

It is assumed that various applications such as a browser, mailer, and scheduler have been installed on the home server 301 and are linked to software according to the present embodiment. Also, e-mails exchanged among users' portable terminals are set to be transferred to the home server 301.

Also, the home server 301 has a database 302 to save various data. The home appliances 303 are electrical appliances used in the home, including, for example, a refrigerator, microwave oven, and washing machine. Besides, according to the present embodiment, the home appliances 303 include a stand-alone phone and personal computer.

(Home Server 301)

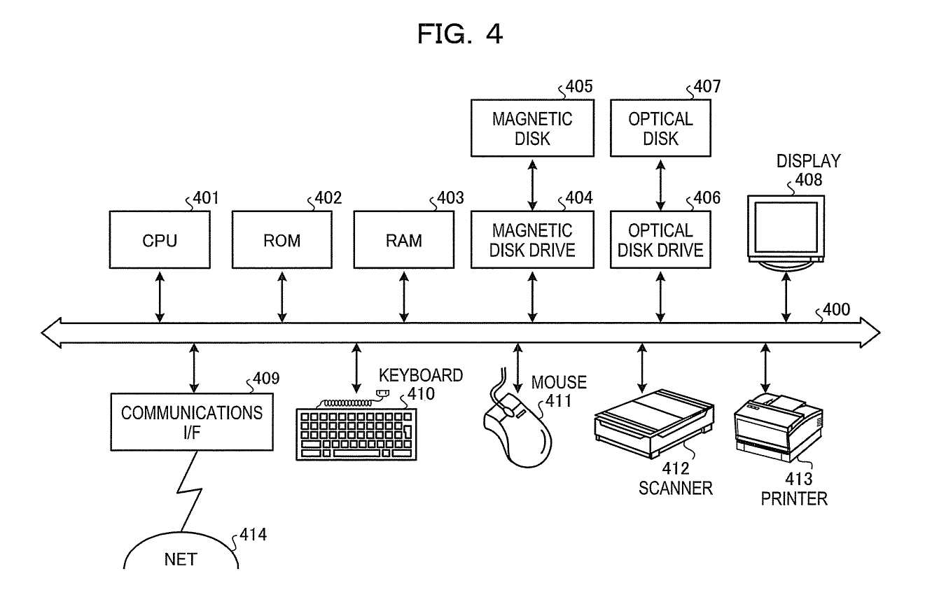

FIG. 4 is a block diagram illustrating the home server 301 according to the present embodiment. In FIG. 4, the home server 301 includes a CPU (Central Processing Unit) 401, ROM (Read-Only Memory) 402, RAM (Random Access Memory) 403, magnetic disk drive 404, magnetic disk 405, optical disk drive 406, optical disk 407, display 408, communications I/F (Interface) 409, keyboard 410, mouse 411, scanner 412, and printer 413. Also, the components are interconnected via a bus 400.

The CPU 401 performs overall control of the home server 301. The ROM 402 stores a boot program and other programs. The RAM 403 is used as a work area of the CPU 401. The magnetic disk drive 404 controls data reads and writes from/to the magnetic disk 405 under the control of the CPU 401. The magnetic disk 405 stores data written under the control of the magnetic disk drive 404.

The optical disk drive 406 controls data reads and writes from/to the optical disk 407 under the control of the CPU 401. The optical disk 407 stores data written under the control of the optical disk drive 406 and causes a computer to read the data stored on the optical disk 407.

The display 408 displays a cursor, icons, and a tool box as well as documents, images, functional information, and other data. The display 408 may be, for example, a CRT, TFT liquid crystal display, or plasma display.

The communications I/F 409 is connected to networks 414 such as the LAN 310, a WAN (Wide Area Network), and the Internet via communication lines. The communication I/F 409 provides an internal interface with the networks 414 and controls input and output of data from/to external apparatuses. The communications I/F 409 may be, for example, a modem or LAN adaptor.

The keyboard 410 is used to enter data, being equipped with keys for use to enter characters, numerals, commands, and the like. Alternatively, touch panel input pad or numeric keypad may be used. The mouse 411 is used to move a cursor, select a range, or move or resize a window. Another device such as a trackball or joystick may be used alternatively as long as the device has similar functions of a pointing device.

The scanner 412 optically reads an image and sends image data into the home server 301. Incidentally, the scanner 412 may be provided with an OCR (Optical Character Reader) function. The printer 413 prints image data and document data. The printer 413 may be, for example, a laser printer or inkjet printer. Processing steps of the home server 301 are either carried out when a program stored in the storage device is executed by the CPU or carried out by the communications I/F 409 (the processing steps are described in examples below).

(Memo Device 101)

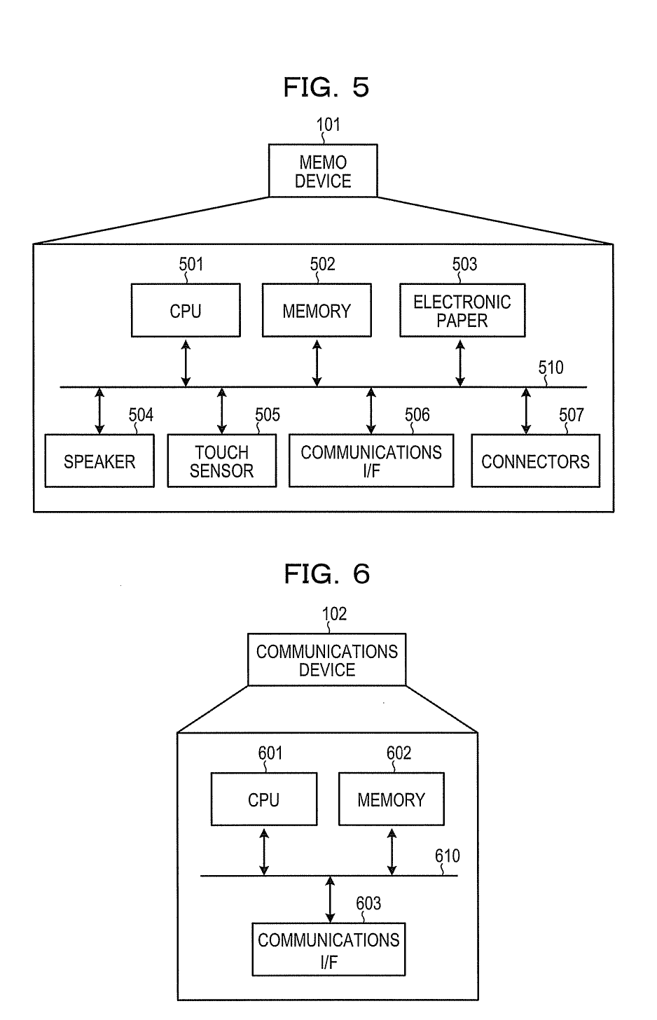

FIG. 5 is a block diagram illustrating a hardware configuration of the memo device 101 according to the present embodiment. The memo device 101 includes, a CPU 501, a memory 502, electronic paper 503, a speaker 504, a touch sensor 505, a communications I/F (Interface) 506, and connectors 507, all of which are interconnected via a bus 510. The CPU 501 performs overall control of the memo device 101. The memory 502 stores various data as well as programs to be executed by the CPU 501. The memory 502 also stores an ID (Identification) unique to the given memo device 101. The electronic paper 503 displays information stored in the memory 502. A liquid crystal or organic EL (Electro-Luminescence) display may be used instead of the electronic paper 503.

The speaker 504 outputs audio information (e.g., recorded data and sound effects) stored in the memory 502, as sound. The touch sensor 505 detects whether the surface of the memo device 101 is touched. The communication I/F 506 conducts contactless communications with the communications device 102 on the board 100. The connectors 507 (201 and 202) are used to connect to another memo device 101, as illustrated in FIG. 2, to enable communications with the other memo device 101. Processing steps of the memo device 101 are either carried out when a program stored in the memory 502 is executed by the CPU 501 or carried out by the communications I/F 506 (the processing steps are described in examples below).

(Communications Device 102)

FIG. 6 is a block diagram illustrating a hardware configuration of the communications device 102 according to the present embodiment. The communications device 102 includes a CPU 601, memory 602, communications I/F 603, and position sensor, all of which are interconnected via a bus 610. The CPU 601 performs overall control of the communications device 102. The memory 602 stores various data as well as programs to be executed by the CPU 601. The communication I/F 603 conduct contactless communications with the communications I/F 506 of the memo device 101. Processing steps of the communications device 102 are either carried out when a program stored in the memory 602 is executed by the CPU 601 or carried out by the communications I/F 603 (the processing steps are described in examples below).

(Data Structure)

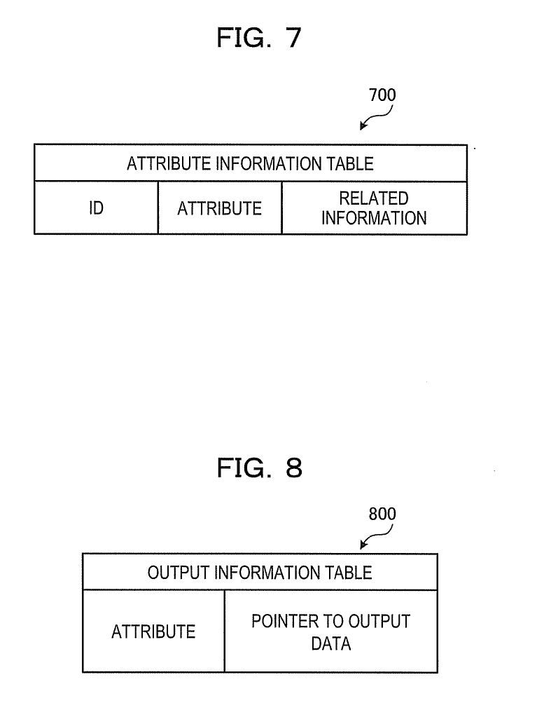

FIG. 7 is an explanatory diagram illustrating a data structure of an attribute information table stored in the database 302 of the home server 301 according to the present embodiment. Attribute information represents features of the memo device 101. The attribute information table 700 contains an ID, an attribute, and related information. The ID is identification information unique to the given memo device 101. The attribute is information which characterizes the memo device 101. This information concerns, for example, type of the user who uses the memo device 101 (e.g., Father, Mother, Child, or the like) and type of information (e.g., Weather, Sports, News, or the like) provided on the memo device 101.

The related information is information about the attribute. For example, in the case of an attribute which concerns the type of user, the related information includes an e-mail address and cell phone number of the user. On the other hand, in the case of an attribute which concerns the type of information provided on the memo device 101, the related information includes location information about a storage area of the provided information. For example, when the information provided on the memo device 101 has been captured into the home server 301, the related information represents a directory which saves the captured information. When the information provided on the memo device 101 is uploaded to a Web site, the related information represents the URL (Uniform Resource Locator) of the Web site.

FIG. 8 is an explanatory diagram illustrating a data structure of an output information table according to the present embodiment. Output information identifies output data to be outputted from the memo device 101. The output information table 800 contains an attribute and a pointer to output data. The attribute is information which characterizes the memo device 101 as in the case of the attribute illustrated in FIG. 7. The pointer to output data represents an address at which the output data is stored. By pointing at output data with the pointer it is possible to read the output data. Possible output data includes, for example, image data, icons, moving-image data, character string data, and voice data. Examples in which the system illustrated in FIGS. 1 to 8 is used will be described below.

### First Example

A first example involves attaching the memo device 101 to the board 100 and displaying information on the memo device 101.

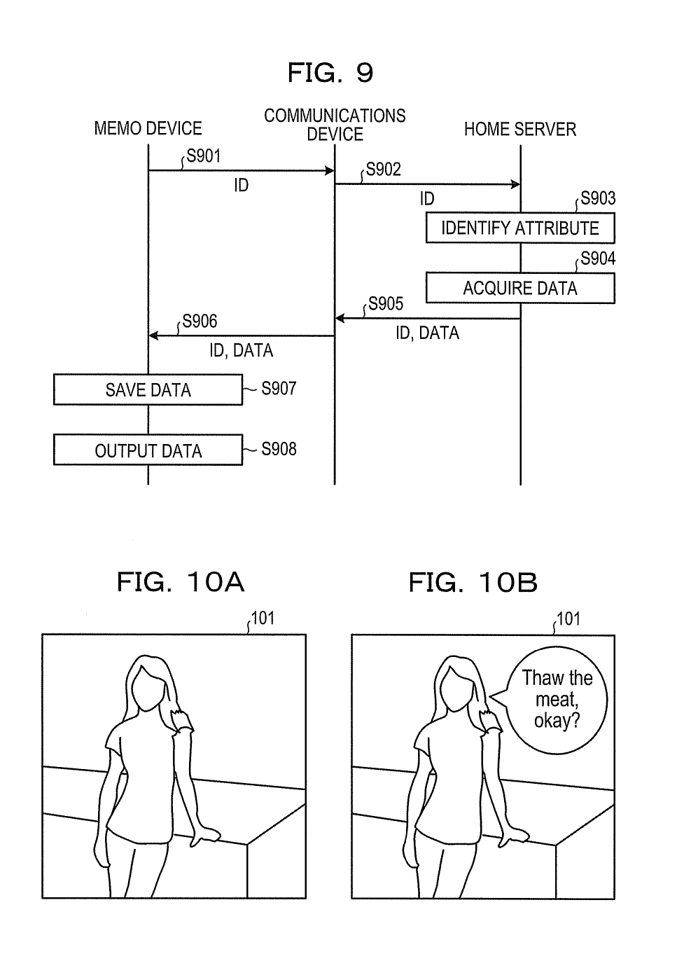

FIG. 9 is a sequence diagram illustrating information providing procedures according to the first example. First, when the memo device 101 is attached to the board 100, contactless communications are conducted between the memo device 101 and the board 100, and the ID stored in the memory 502 of the memo device 101 is transmitted to the communications device 102 (Step S901). The communications device 102 transmits the received ID to the home server 301 via the LAN 310 (Step S902).

Upon receiving the ID, the home server 301 identifies the attribute of a record corresponding to the received ID with the ID stored in the attribute information table 700 illustrated in FIG. 7 (Step S903). Once the attribute is identified, the home server 301 acquires output data with reference to the pointer to the output data using the output information table 800 illustrated in FIG. 8 (Step S904). Then, the home server 301 transmits the ID received in Step S902 and the output data acquired in Step S904 to the communications device 102 (Step S905).

The communications device 102 transmits the received ID and output data to the memo device 101 which corresponds to the ID (Step S906). The memo device 101 saves the output data received from the communications device 102 in the memory 502 (Step S907). Then, the memo device 101 outputs the output data saved in the memory 502 (Step S908). When the output data is visible data such as image data, moving-image data, icons, or character string data the output data is displayed on the electronic paper 503.

On the other hand, if the output data is voice data, when the touch sensor 505 detects that the memo device 101 has been touched by the user, the memo device 101 plays back the voice data saved in the memory 502 (Step S908). Moving-image data may also be read out of the memory 502 and played back when the touch sensor 505 detects touch.

For example, as illustrated in FIG. 1, when a memo device 101 whose attribute is Child is attached to the board 100, image data of the child is displayed on the memo device 101. In this way, according to the first example, the memo device 101 of each individual can be attached to the board 100 as if it were a sticker, making it possible to identify which memo device 101 represents whom.

This makes it possible to convey or provide various information such as a calendar or messages, with memo devices 101 being associated with users, by freely writing something in margins of the board 100, the margins containing no memo device 101. In this way, the first example eliminates the need for complicated computer operations, making it possible to provide information in much the same way as affixing paper on a message board or affixing paper on a white board or black board using a magnet.

### Second Example

A second example involves applying data received externally to the memo device 101.

FIGS. 10A and 10B are explanatory diagrams illustrating an example of how information is displayed on the memo device 101 according to the second example. FIG. 10A illustrates a memo device 101 of Mother who is one of users, i.e., a memo device 101 whose attribute is Mother. The memo device 101 displays image data of the mother.

For example, if the mother mails a message “Thaw the meat, okay?” from the road to a mail address assigned to the home server 301 using a cell phone, the character string data “Thaw the meat, okay?” is displayed on the Mother's memo device 101, as illustrated in FIG. 10B, by being transferred from the home server 301. In the case of voice data rather than character string data, the user can play back the voice data by touching the memo device 101.

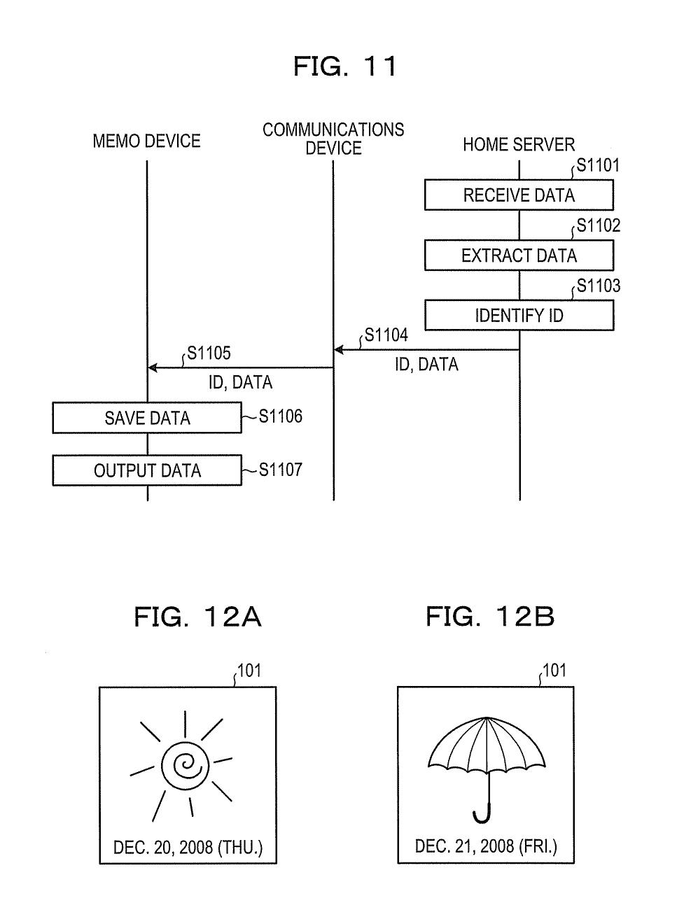

FIG. 11 is a sequence diagram illustrating information providing procedures according to the second example. Upon receiving an e-mail from outside (Step S1101), the home server 301 extracts output data from the e-mail (Step S1102). In this case, the home server 301 extracts the character string data “Thaw the meat, okay?” which is the mail body of the e-mail.

Then, in the attribute information table 700, the home server 301 identifies an ID which has the sender address of the e-mail as related information (Step S1103). The home server 301 transmits the ID identified in Step S1103 and the data extracted in Step S1102 to the communications device 102 (Step S1104). The communications device 102 transmits the received data to the memo device 101 using the received ID as an address (Step S1105).

The memo device 101 saves the data (the character string data “Thaw the meat, okay?”) received from the communications device 102 in the memory 502 (Step S1106) and outputs the output data saved in the memory 502 (Step S1107). In this case, the memo device 101, which has been displaying image data of the mother as illustrated in FIG. 10A, displays the received character string data while displaying the image data of the mother. Areas available to display character string data may be specified in advance, for example, as areas other than those for portrait images. Since the character string data is displayed on the Mother's memo device 101, it can be seen intuitively whose message it is.

In this way, according to the second example, desired information can be sent from the road to make the memo device 101 output the information. Thus, even when it is not possible to convey information to a desired person (e.g., when the person does not have a cell phone, when the person is located out of service range even if the person has a cell phone, when the phone has run out of battery power, or when the person does not check his/her cell phone), if a message is sent to the memo device 101, the a message can be conveyed to the child who returns home. In this way, even when away from home, family members can use the memo device 101 as a message board as if they were at home. In addition to transmission of e-mails, the memo device 101 can similarly be used to update weather information.

FIGS. 12A and 12B are explanatory diagrams illustrating a memo device 101 whose attribute is Weather. FIG. 12A shows the weather on Dec. 20, 2008 by a sun mark. Upon receiving tomorrow's weather information (rain, in this case), the home server 301 identifies the ID which has the destination URL of the weather information as related information in the attribute information table 700 and transfers the weather information to the memo device 101 of the identified ID via the communications device 102.

The memo device 101 displays tomorrow's weather using an umbrella mark. In this way, if the memo device 101 is simply attached to the board 100, the weather forecast, which is updated automatically on the board 100, comes into sight as the family members lead a normal life at home even if they do not check weather information by themselves.

### Third Example

A third example involves providing information by mounting a camera device on the memo device 101.

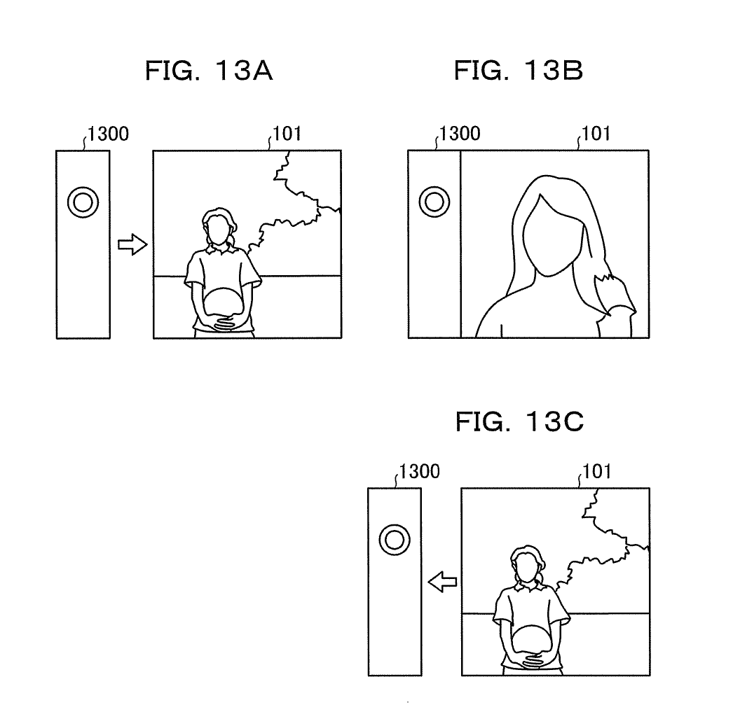

FIGS. 13A to 13C are explanatory diagrams illustrating an example of how the memo device 101 is used according to the third example. According to the third example, image data captured by a camera device 1300 is transmitted from the memo device 101 to a destination terminal. FIGS. 13A to 13C illustrates an example of sending Mother's image data from a memo device 101 assigned to Child to a Child's portable terminal.

First, in FIG. 13A, the connector 507 of the Child's memo device 101 and the connector 507 of the camera device 1300 are interconnected, thereby mounting the camera device 1300. During mounting, the memo device 101 may be detached from the board 100. When the camera device 1300 is mounted (FIG. 13B), the display screen 200 of the memo device 101 is switched from Child's image data illustrated in FIG. 13A to a subject's video data received from the camera device 1300.

In this case, video data of Mother who is the subject is displayed. Then, when a trigger is given to the memo device 101 by remote control from the camera device 1300 or by touch on the memo device 101, a shutter of the camera device 1300 is released to capture image data. When attached to the board 100, the memo device 101 conducts contactless communications with the communications device 102, and consequently the captured image data is transmitted to an e-mail address of the Child's cell phone. When the camera device 1300 is subsequently removed from the memo device 101 (FIG. 13C), the display screen 200 of the memo device 101 returns to the Child's image data displayed originally.

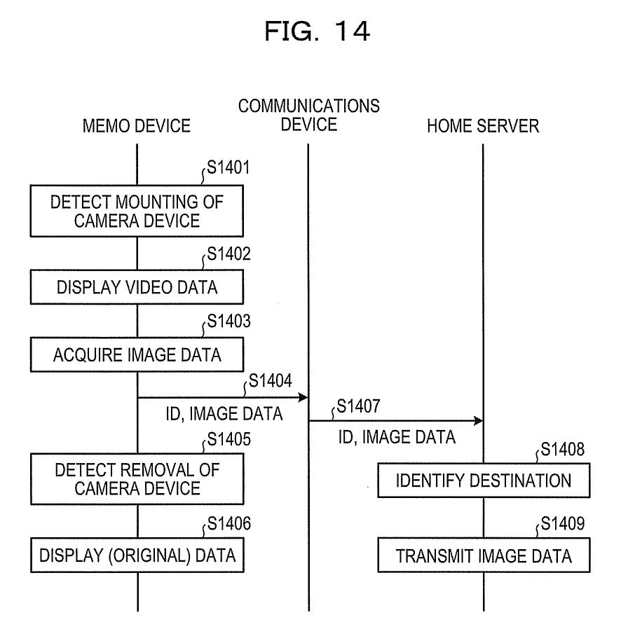

FIG. 14 is a sequence diagram illustrating information providing procedures according to the third example. First, upon detecting that the camera device 1300 has been mounted as illustrated in FIG. 13A (Step S1401), the memo device 101 displays video data from the camera device 1300 on the display screen 200 of the memo device 101 as illustrated in FIG. 13B (Step S1402), acquires image data when a trigger is given (Step S1403), and transmits the image data to the communications device 102 together with the ID stored in the memory 502 (Step S1404).

Subsequently, when removal of the camera device 1300 from the memo device 101 is detected (Step S1405), the data originally displayed before the mounting of the camera device 130 is displayed on the display screen 200 of the memo device 101 (Step S1406). On the other hand, upon receiving the ID and image data from the memo device 101, the communications device 102 transfers them as they are to the home server 301 (Step S1407).

The home server 301 receives the transferred ID and image data, and identifies the e-mail address of a record corresponding to the received ID among items of related information in the attribute information table 700 using the received ID (Step S1408). The identified e-mail address is the e-mail address (destination) of Child, which is the attribute of the record corresponding to the received ID. Then, the home server 301 transmits the image data received in Step S1407 to the e-mail address identified in Step S1408 (Step S1409).

In this way, the third example makes it possible to photograph with the camera device 130 mounted on the memo device 101 and then send image data shot by the camera device 130 to the e-mail address of the user of the memo device 101, by simply attaching the memo device 101 to the board 100. This eliminates the need for complicated operating procedures such as destination setting and allows information to be provided through intuitive operation.

### Fourth Example

A fourth example involves connecting two memo devices 101 together to extend a display area.

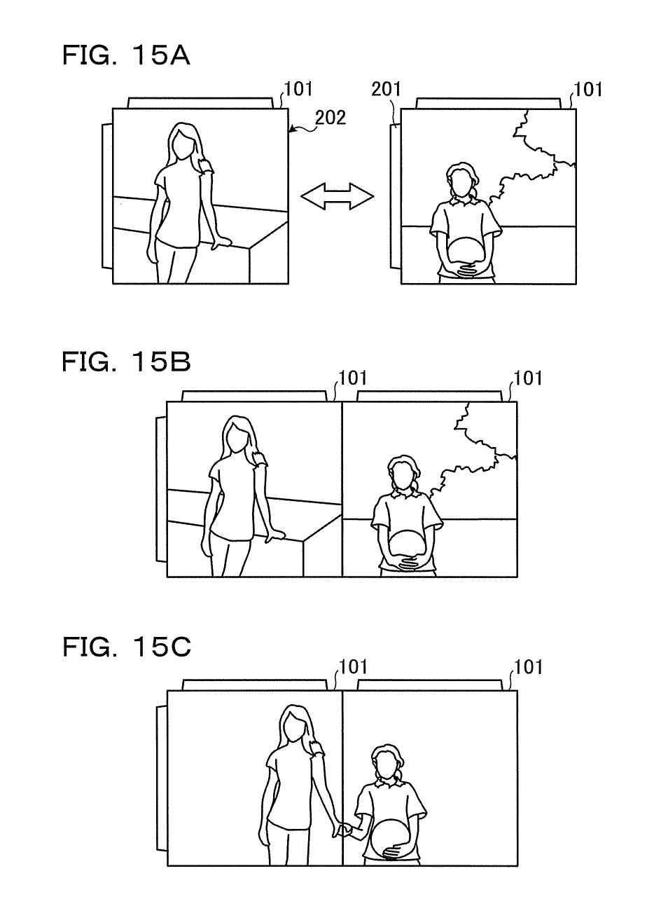

FIGS. 15A to 15C are explanatory diagrams illustrating an example of how a display area is extended, according to the fourth example. In this case, the Mother's memo device 101 (on the left side of FIGS. 15A to 15C) and Child's memo device 101 (on the right side of FIGS. 15A to 15C) are connected side by side. In FIG. 15A, the female connector 202 on the left end face of the Mother's memo device 101 and the male connector 201 on the right end face of the Child's memo device 101 are placed face to face.

Next, the female connector 202 on the left end face of the Mother's memo device 101 and the male connector 201 on the right end face of the Child's memo device 101 are connected with each other. Consequently, in FIG. 15C, a display area which combines the display screen 200 of the Mother's memo device 101 and the display screen 200 of the Child's memo device 101 displays image data which shows both Mother and Child.

(Data Structure)

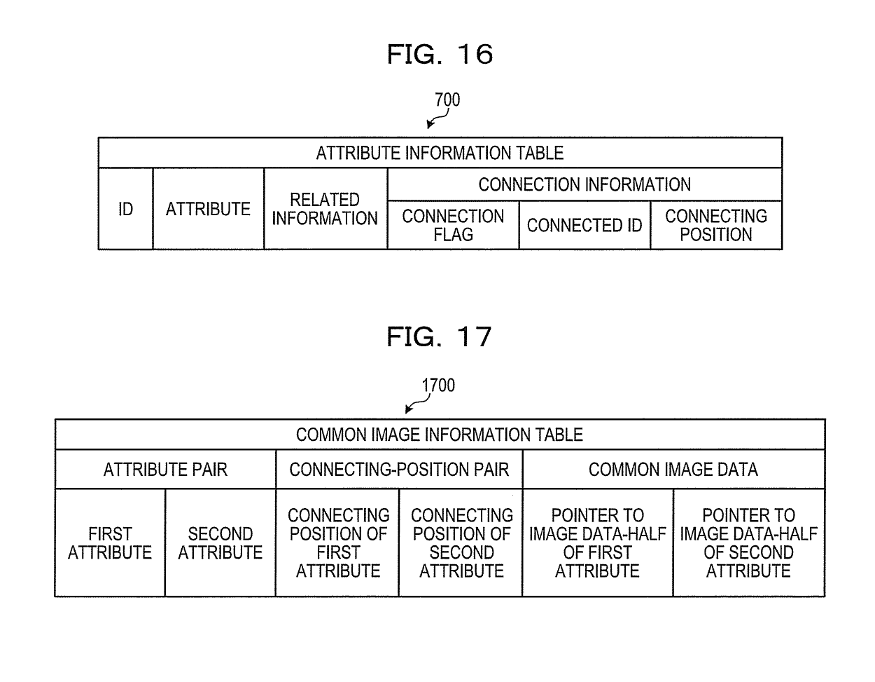

FIG. 16 is an explanatory diagram illustrating a data structure of the attribute information table 700 according to the fourth example. The attribute information table 700 according to the fourth example contains connection information in addition to the ID, attribute, and related information illustrated in FIG. 7. The connection information, which is written when another memo device 101 is connected, identifies state of connection with the other memo device 101. The connection information includes a connection flag, connected ID, and connecting position.

The connection flag identifies whether the given memo device 101 is connected with another memo device 101. The connected ID is the ID of the other memo device 101 connected. The connecting position is position relative to the connected device. For the Mother's memo device 101 in FIGS. 15A to 15C, for example, the Child's memo device 101 is the other memo device 101. In this case, since the Mother's memo device 101 is located on the right as viewed from the Child's memo device 101, the connecting position is Right.

FIG. 17 is an explanatory diagram illustrating a data structure of a common image information table. The common image information table 1700 is stored in the database 302 of the home server 301. Common image information characterizes image data which shows two users (common image data). The common image information table 1700 contains an attribute pair, a connecting-position pair, and pointers to common image data. The attribute pair is a combination of the attributes of the two users. One of the attributes is designated as a first attribute and the other attribute is designated as a second attribute. In the example illustrated in FIGS. 15A to 15C, the first attribute is Mother and the second attribute is Child.

The connecting-position pair is a combination of the connecting position for the first attribute and connecting position for the second attribute. Each of the connecting positions is linked to the connecting position in the attribute information table 700 illustrated in FIG. 16. In the example illustrated in FIGS. 15A to 15C, the connecting position for the first attribute corresponds to the connecting position in the record whose attribute is Mother in the attribute information table 700. Similarly, the connecting position for the second attribute corresponds to the connecting position in the record whose attribute is Child in the attribute information table 700.

The pointers to the common image data are a combination of a pointer to an image data-half of the first attribute and a pointer to an image data-half of the second attribute. The image data-half is each half obtained by splitting the common image data in two.

In the example illustrated in FIGS. 15A to 15C, the image data displayed in the Mother's memo device 101 in FIG. 15C is the image data-half of the first attribute and the image data displayed in the Child's memo device 101 is the image data-half of the second attribute.

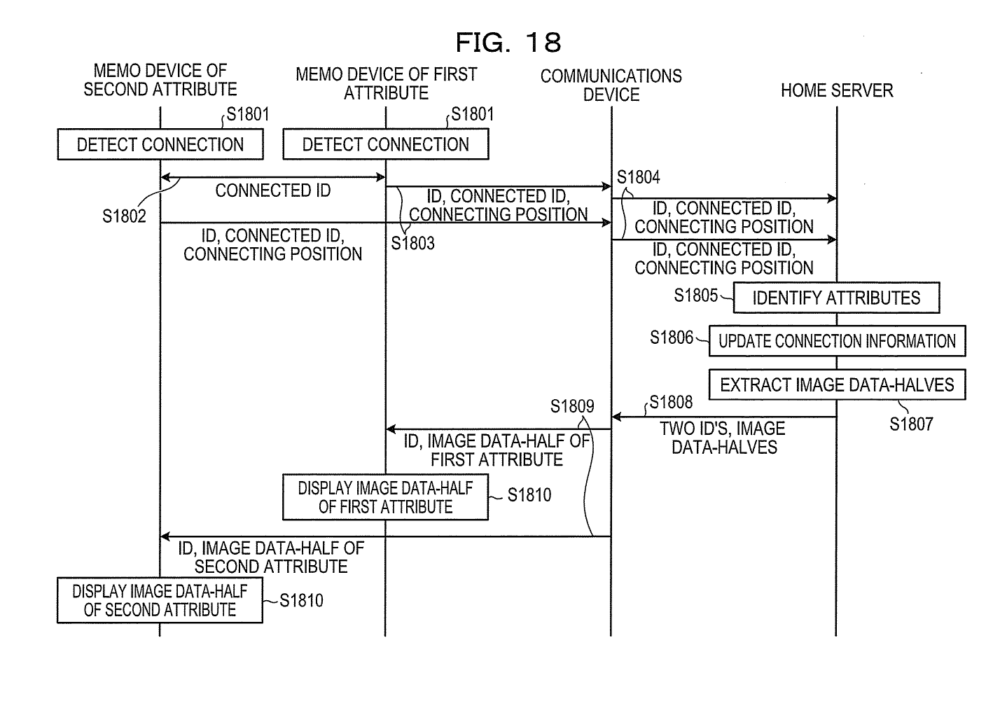

FIG. 18 is a sequence diagram (Part 1) illustrating information providing procedures according to the fourth example. First, the memo device 101 of the first attribute (Mother) and memo device 101 of the second attribute (Child) to be connected with each other detect the connecting positions of each other (Step S1801). In the detection, the mating connectors 507 identify the connecting positions of each other.

Next, by exchanging IDs, the connected IDs are received (Step S1802). Then, when attached to the board 100, each of the connected memo devices 101 conducts contactless communications with the communications device 102, and thereby transmits the ID, connected ID, and connecting position to the communications device 102 (Step S1803). The communications device 102 transfers the received IDs, connected IDs, and connecting positions to the home server 301 (Step S1804).

The home server 301 receives the IDs, connected IDs, and connecting positions transmitted from the communications device 102. Then, the home server 301 identifies the attributes of records corresponding to the received IDs in the attribute information table 700 illustrated in FIG. 16 using the received ID (Step S1805). Then, the home server 301 turns on the connection flag in the connection information in each of the records, writes the connected ID and connecting position, and thereby updates the connection information (Step S1806).

At this time, in the attribute information table 700, the record with the first attribute (Mother) has its connection flag set to ON, the connected ID set to the ID of the memo device 101 of the second attribute, and the connecting position set to Right. Similarly, in the attribute information table 700, the record with the second attribute (Child) has its connection flag set to ON, the connected ID set to the ID of the memo device 101 of the first attribute, and the connecting position set to Left.

Next, the home server 301 identifies an attribute pair and connecting-position pair whose connection flags have turned on in the attribute information table 700 and identifies the pointers to the common image data (pointer to the image data-half of the first attribute and pointer to the image data-half of the second attribute) in the common image information table 1700. In the example described above, in a record whose attribute pair is Mother and Child and whose connecting-position pair is Right and Left, the home server 301 identifies the pointer to the image data-half of the first attribute (Mother) and pointer to the image data-half of the second attribute (Child). Using the two pointers, the image data-half of the first attribute and image data-half of the second attribute are extracted from the database 302 (Step S1807).

Once the image data-halves are extracted, the home server 301 transmits the image data-halves to the communications device 102 together with the IDs used to identify the respective attributes (Step S1808). Specifically, for example, the home server 301 transmits a set of the image data-half of the first attribute and the ID of the memo device 101 of the first attribute as well as a set of the image data-half of the second attribute and the ID of the memo device 101 of the second attribute to the communications device 102.

Using the ID attached to each image data-half as an address, the communications device 102 transfers the image data-halves to the memo devices 101 of the respective IDs (Step S1809). Specifically, for example, the communications device 102 transmits the image data-half of the first attribute to the memo device 101 of the first attribute, and the image data-half of the second attribute to the memo device 101 of the second attribute.

Upon receiving the image data-halves, the memo device 101 displays the received image data-halves on the display screen 200 (Step S1810). Specifically, for example, as illustrated in FIG. 15C, the memo device 101 of the first attribute displays the image data-half of the first attribute and the memo device 101 of the second attribute displays the image data-half of the second attribute. Consequently, as illustrated in FIG. 15C, two screens of image data (common image data) can be displayed according to a combination of the users of the interconnected memo devices 101.

With the common image data being displayed, data received externally may be displayed in superposition as illustrated in the second example. For example, the home server 301 may receive an e-mail from Mother that is the first attribute and display the mail body on the display screen 200 of the memo device 101 of the first attribute.

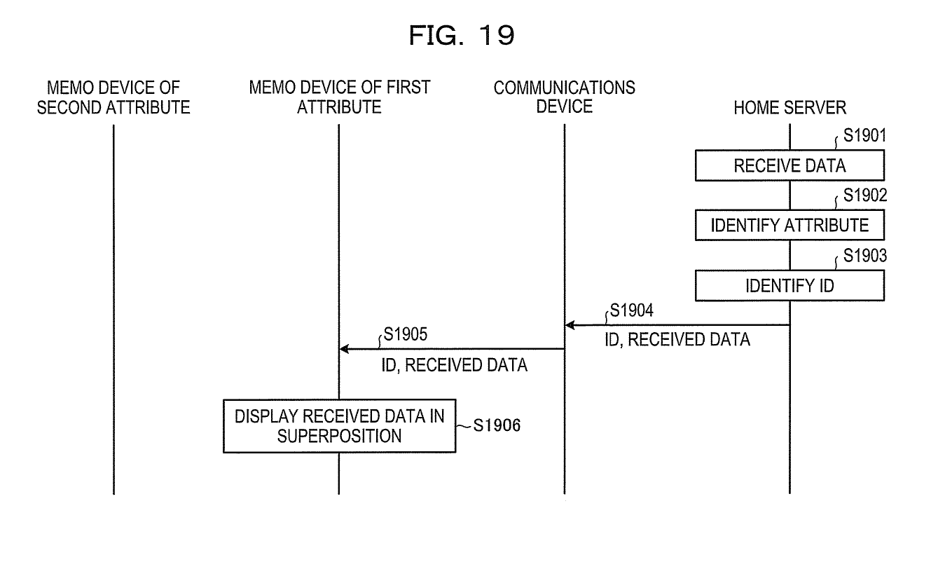

FIG. 19 is a sequence diagram (Part 2) illustrating the information providing procedures according to the fourth example. It is assumed that the memo device 101 of the first attribute is displaying image data-half of the first attribute while the memo device 101 of the second attribute is displaying image data-half of the second attribute.

Upon receiving an e-mail (Step S1901), the home server 301 identifies the attribute which has the sender address of the e-mail as related information, in the attribute information table 700. Similarly, the home server 301 identifies the attribute which has the destination address of the e-mail as related information, in the attribute information table 700 (Step S1902).

Specifically, for example, when the sender is a Mother's portable terminal, the attribute Mother which has the e-mail address of the Mother's portable terminal as related information is identified. Similarly, the attribute Child which has the destination e-mail address of the Child's portable terminal as related information is identified.

Then, the home server 301 determines whether or not the identified attribute pair has been registered in the common image information table 1700. If the attribute pair has been registered in the common image information table 1700, the home server 301 identifies the ID which corresponds to the attribute of the sender, in the attribute information table 700 (Step S1903). Specifically, for example, if an attribute pair Mother and Child has been registered in the common image information table 1700, the home server 301 identifies the ID of the memo device 101 used by the attribute Mother, in the attribute information table 700.

Subsequently, the home server 301 transmits the ID identified in Step S1903 and the received data (only the mail body, in this case) to the communications device 102 (Step S1904). The communications device 102 transfers the received data to the memo device 101 of the first attribute (Step S1905). The memo device 101 of the first attribute displays the received data, i.e., the character string data of the mail body on its display screen 200 (Step S1906).

Areas available to display character string data may be specified in advance, for example, as areas other than those for portrait images. Since the character string data is displayed only on the memo device 101 of Mother that is the first attribute, it can be seen intuitively which user the message has originated from and which user the message is directed at.

### Fifth Example

A fifth example involves using the board 100 as a calendar.

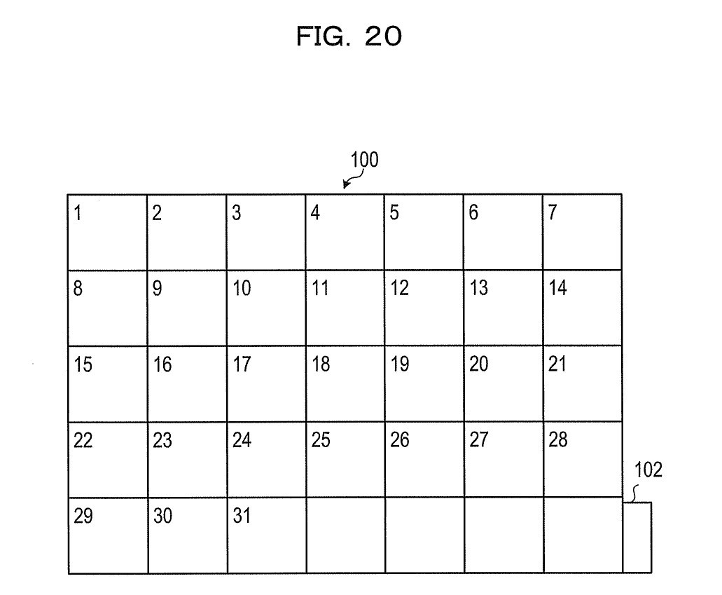

FIG. 20 is a plan view of the board 100 according to a fifth example. A surface of the board 100 is divided into a matrix of cells which correspond to dates.

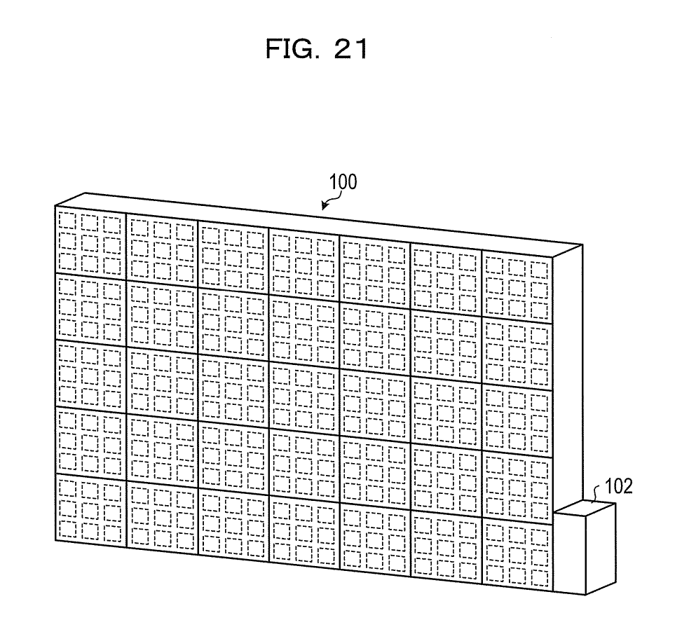

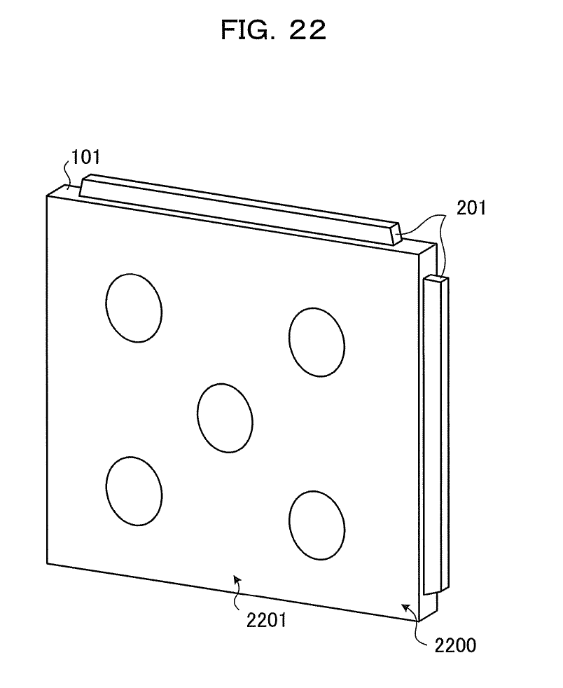

FIG. 21 is a perspective view of the board 100 according to the fifth example. As illustrated in FIG. 21, in each cell of the matrix, a matrix of multiple magnets (3×3 magnets, in FIG. 21) are buried (the magnets are indicated by dotted lines in FIG. 21).

FIG. 22 is a perspective view illustrating an external appearance of the memo device 101 when viewed from behind. A specific magnet pattern 2201 is provided in a rear face 2200 of the memo device 101. The location of the memo device 101 can be identified as the board 100 recognizes the specific magnet pattern 2201.

Specifically, when a memo device 101 is attached to an arbitrary cell illustrated in FIG. 21, a magnetic field is produced between the specific magnet pattern 2201 and the magnets facing it. A magnetic sensor is buried in the board 100, and it can be determined, based on a detected magnetic pattern, which memo device 101 is attached and to which cell.

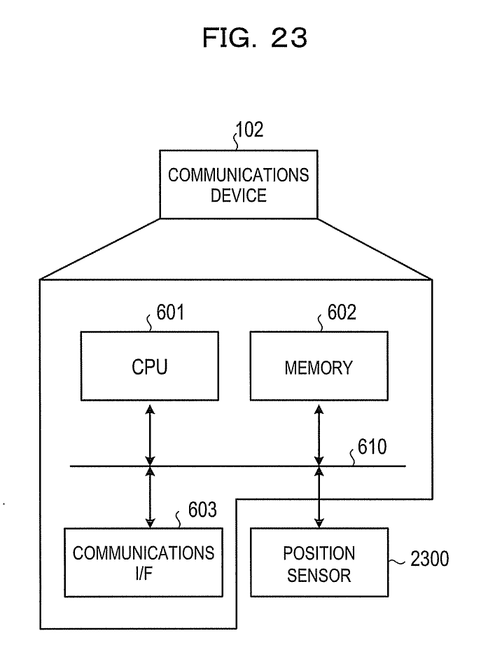

FIG. 23 is a block diagram illustrating a hardware configuration of the communications device 102 according to the fifth example. The same components as those in FIG. 6 are denoted by the same reference numerals as the corresponding components in FIG. 6. In FIG. 23, a position sensor 2300 is newly buried in the board 100 and connected to the bus 610. The position sensor 2300 detects the position of the memo device 101 attached to the board 100. The position sensor 2300 may, for example, be a magnetic sensor, as described above. The position sensor 2300 saves detected-position information in the memory 602 of the communications device 102, where the position information is given by coordinate values (e.g., position coordinates of the central magnet out of the magnets which produces magnetic fields).

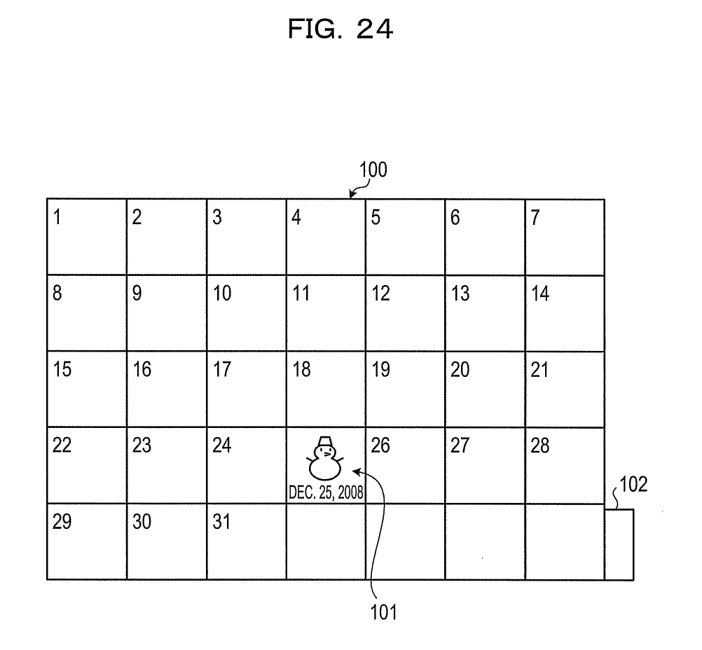

FIG. 24 is an explanatory diagram illustrating an example of how a memo device 101 whose attribute is Weather is attached, according to the fifth example. In FIG. 24, the memo device 101 whose attribute is Weather is attached to the 25th day. Based on the sequence according to the first example in FIG. 9, the display screen 200 of the memo device 101 displays a weather forecast for Dec. 25, 2008.

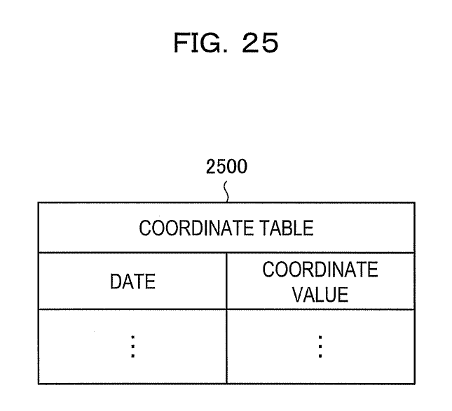

FIG. 25 is an explanatory diagram illustrating a coordinate table. The coordinate table 2500 is stored in the database 302 of the home server 301. The coordinate table 2500 associates dates with coordinate values. Each date corresponds to a cell of the board 100 and the coordinate values represent values of specific position coordinates of the cell (which alternatively may be center coordinates of the cell or coordinates of one of four vertices). Both vertical and horizontal lengths of the cells are constant, and thus the specific position coordinates allow a specific region in the given cell to be identified.

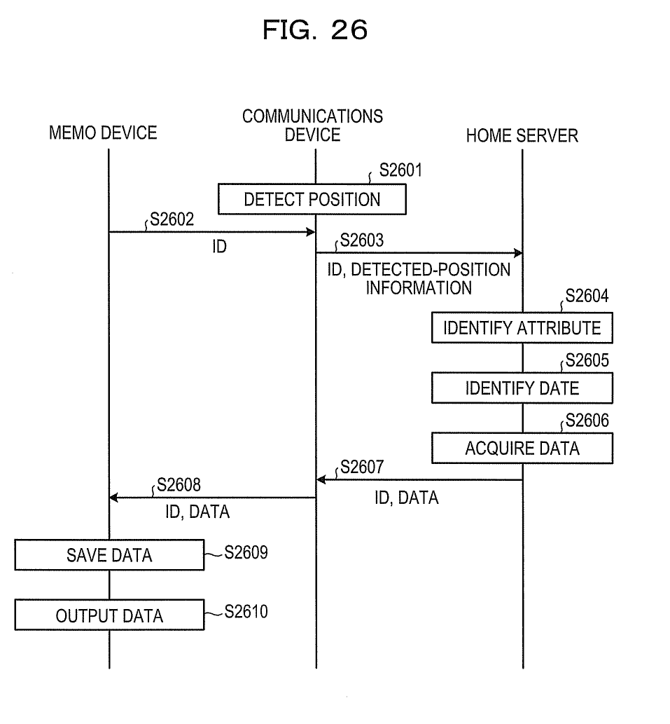

FIG. 26 is a sequence diagram illustrating information providing procedures according to the fifth example. When a memo device 101 is attached to the board 100, the communications device 102 performs position detection (Step S2601). Specifically, the position sensor 2300 saves the position coordinates at which the memo device 101 is attached, as detected-position information, in the memory 602. Once attached, the memo device 101 conducts contactless communications with the communications device 102, and thereby sends the ID of the memo device 101 to the communications device 102 (Step S2602).

Upon receiving the ID, the communications device 102 transmits the received ID together with the detected-position information to the home server 301 (Step S2603). Upon receiving the ID and detected-position information, the home server 301 identifies the attribute of the received ID with reference to the attribute information table 700 (Step S2604). Then, the home server 301 identifies the date which contains the received detected-position information with reference to the coordinate table 2500 (Step S2605). Specifically, the home server 301 identifies the date's region which includes the coordinate values of the detected-position information.

Also, the home server 301 acquires data for the date identified in Step S2605 (Step S2606). Specifically, for example, if an application which acquires weather information has been installed on the home server 301 or when the home server 301 is monitoring a Web site on which weather information has been uploaded, the home server 301 acquires weather information for the date identified in Step S2605. In this case, the home server 301 acquires weather information for Dec. 25, 2008.

Then, the home server 301 transmits the ID received in Step S2603 and data received in Step S2606 to the communications device 102 (Step S2607). The communications device 102 transfers the data (weather information) received in Step S2607 to the memo device 101 of the received ID (Step S2608). The memo device 101 saves the data received from the communications device 102 in the memory 502 (Step S2609) and outputs the data (displays the weather information) (Step S2610).

Consequently, as illustrated in FIG. 24, the weather forecast for Dec. 25, 2008 is displayed on the memo device 101 attached to the cell of the 25th day. In this way, the fifth example makes it possible to identify the location to which the memo device 101 is attached and provide the memo device 101 with information unique to the attaching location.

Thus, by simply selecting a memo device 101 of a specific attribute type (e.g., Weather, Sports, News, or the like) and attaching the selected memo device 101 to the cell of a desired date on the board 100, the user can obtain information of the selected attribute type for the given date. Consequently, the user can automatically acquire information specialized to the attaching location by the act of attaching the memo device 101, which is hard to imagine to be a computer operation. Thus, even if there is someone in the family who is computer illiterate, all the family members can use the information.

### Sixth Example

A sixth example is an example of use at an office. It is assumed that users are company employees and that a memo device 101 is provided for each employee. Also, it is assumed that in addition to the ID of the memo device 101, the memo device 101 stores an employee identification number unique to the given employee as an attribute.

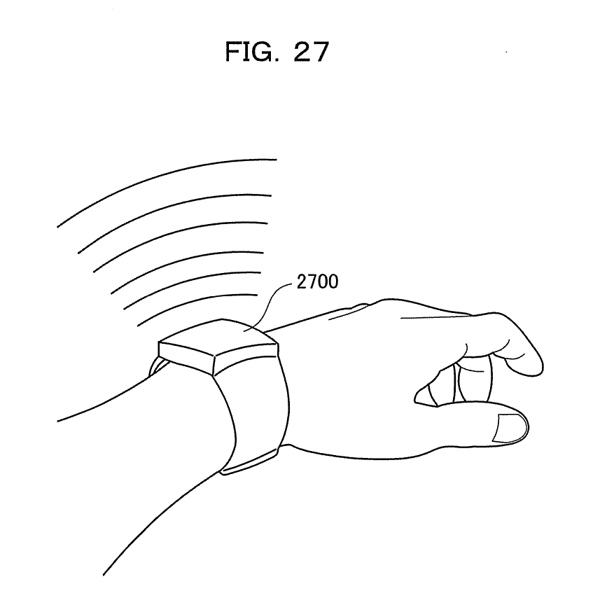

FIG. 27 is an explanatory diagram illustrating a biomedical sensor. The biomedical sensor 2700, which is a wristband type in this case, detects biomedical information such as pulse rate and body temperature. The biomedical sensor 2700 periodically uploads the detected biomedical information to the home server 301 together with the attribute (employee identification number) of the employee.

It is assumed that an existing application which analyzes physical conditions based on the biomedical information has been installed on the home server 301. Analysis results of physical conditions produced by the application is transmitted to the memo device 101 of the analyzed employee using a sequence similar to the one illustrated in the second example. The analysis results transmitted are displayed on the display screen 200 of the memo device 101.

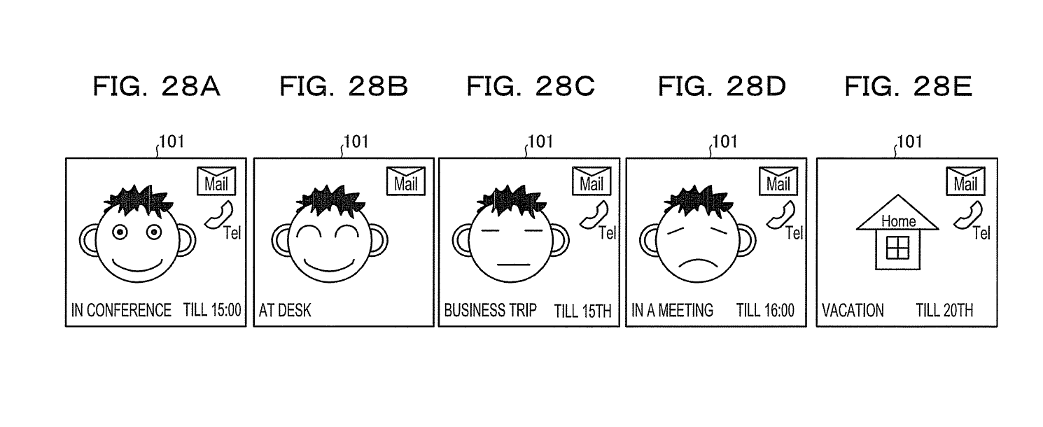

FIGS. 28A to 28E are explanatory diagrams illustrating analysis results of physical conditions displayed on the memo device 101. In FIGS. 28A to 28E, the physical conditions are represented by images of facial expressions. The scheduler and mailer installed on the home server 301 are linked to the application according to the sixth example and display a schedule for a conference or arrival of an e-mail or phone call using text or icons. Such provision of information is implemented using a sequence similar to the one illustrated in the second example.

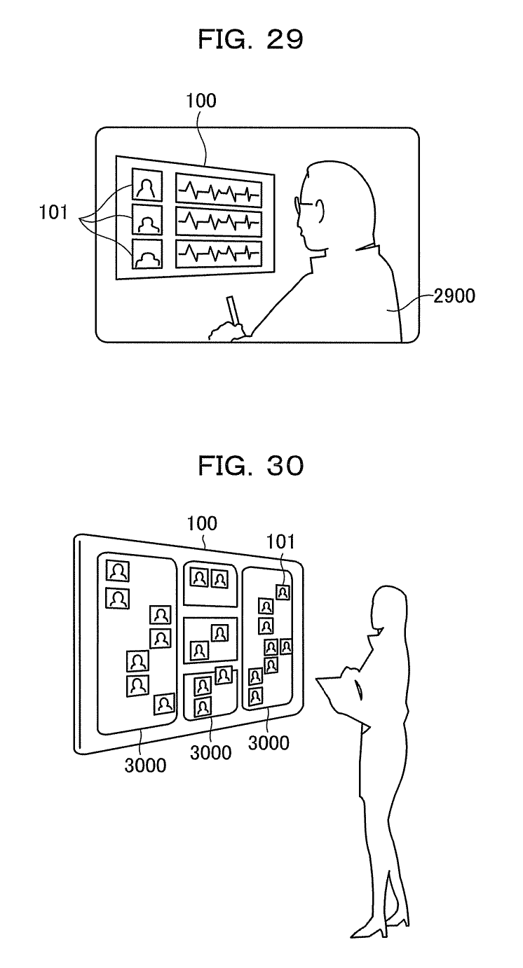

FIG. 29 is an explanatory diagram illustrating a usage scene (Part 1) in an office. The board 100 is posted on a surface of a wall in a medical treatment room. The memo devices 101 of the employees are attached to the board 100. The memo devices 101 display physical conditions of the employees as illustrated in FIG. 28. An industrial physician 2900 manages the health of the employees with reference to the analysis results of their physical conditions. In this way, by keeping track of the physical conditions of the employees in real time, even if any employee becomes ill or gets out of shape, it is possible to give treatment before symptoms become severe.

FIG. 30 is an explanatory diagram illustrating a usage scene (Part 2) in an office. In FIG. 30, the board 100 is posted on a surface of a wall in the office and a region 3000 is assigned to each department. The memo devices 101 of the employees in each department are attached to the region 3000 assigned to the department and each memo device 101 displays a face image of the employee who uses the memo device 101.

That is, the employees whose memo devices 101 are attached are present at the office while the employees whose memo devices 101 are not attached are yet to come to the office. Also, if arrival time is displayed on the display screen 200 of the memo device 101, the memo device 101 can be used as a time recorder. Such provision of information can also be implemented using a sequence similar to the one illustrated in the second example.

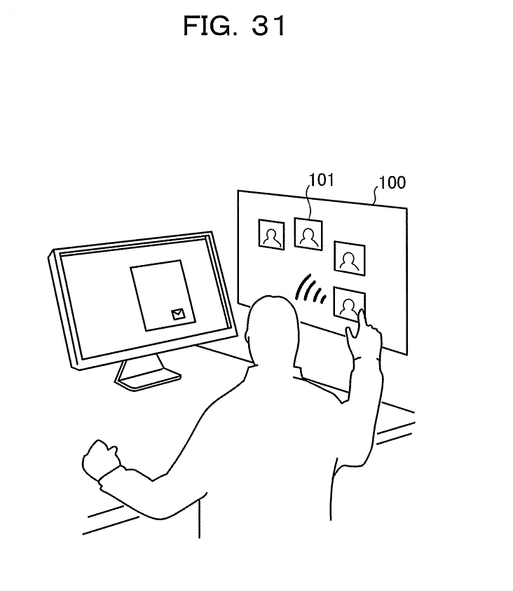

FIG. 31 is an explanatory diagram illustrating a usage scene (Part 3) in an office. In the usage scene in FIG. 31, a board 100 is installed on a wall by the desk of an employee and the memo devices 101 of other employees are attached to the board 100. Character string data from the other employees is sent using a sequence similar to the one illustrated in the second example and displayed on the display screens 200 of the respective memo devices 101. In the case of voice data rather than character string data, the data is stored in the memory 502 of the memo device 101. Then, the voice data is read out of the memory 502 and played back when the memo device 101 is touched.

In this way, by simply looking at the display screen 200 of an employee's memo device 101, it can be seen what message the employee wants to convey, without starting mailer or messenger software or searching for the sender. Also, since voice data of another employee can be played back by simply touching the memo device 101 of the other employee, it is possible to listen to the message of the other employee any number of times without the need for a recorder.

As described above, the present embodiment can implement traditional communications in much the same way as affixing a memo on a white board or black board without making the users aware of computer processing or computer operation. Thus, the present embodiment provides an interface that all members can use intuitively even if there are computer-illiterate persons in the family or corporate organization, and thereby facilitates communications.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. The communications system comprising:
a board;
a storage unit for storing information;
a portable display apparatus comprising;
a memory for storing identification information,
a first transmitter for transmitting information,
a first receiver for receiving information,
a display unit for displaying information,
the portable display apparatus having portability such that the board allows the portable display apparatus to be placed at an arbitrary position upon the board, and
a housing; and
a communication apparatus comprising;
a second receiver for receiving the identification information from the portable display apparatus when the housing of the portable display apparatus is placed upon the board,
an acquisition unit for acquiring from the storage unit the information related to the identification information which is received from the portable display apparatus,
a second transmitter for transmitting to the portable display apparatus the information which is acquired by the acquisition unit;
wherein when the housing of the portable display apparatus is placed on the board, the portable display apparatus receives the information acquired by the acquisition unit from the information by the first receiver and displays the acquired information on the portable display apparatus.

2. The communication system according claim 1,
wherein the second receiver receives the identification information from the portable display apparatus when the housing of the portable display apparatus is placed at a position upon the board; and
wherein the acquisition unit acquires from the storage unit the information being related to both the position and the identification information which is received from the portable display apparatus.

3. The communication system according claim 2,
wherein the acquisition unit acquires from the storage unit the information which relates to both the date corresponding of the position and the identification information being received from the portable display apparatus.

4. The communication system according claim 1,
wherein the portable display apparatus is tentatively secured at on an arbitrary position upon the board.

5. The communication system according claim 1,
wherein the information stored in the storage is graphic information.

6. The communication system according claim 1, comprising:
a plurality of the portable display apparatuses;
wherein the plurality of the portable display apparatuses respectively comprises a detector for detecting to connect with at least one of other the portable display apparatuses;
wherein when the second receiver receives two or more the identification information and at least one of the detector detects to connect with at least one of other the portable display apparatuses, the acquisition unit acquires from the storage unit the information related to both of the identification information which are received from the portable display apparatus,
wherein the acquisition unit divides the information which acquired from the storage unit, and
wherein the second transmitter transmits each the divided information to each the portable display apparatuses which transmitted the identification information.

7. A communication apparatus for communicating with a storage unit and a portable display apparatus for displaying information, the communication apparatus comprising:
a receiver for receiving an identification information from the portable display apparatus when the portable display apparatus is placed upon the board;
an acquisition unit for acquiring from the storage unit the information related to the identification information which is received from the portable display apparatus; and
a transmitter for transmitting to the portable display apparatus the information which is acquired by the acquisition unit.

8. The communication apparatus according claim 7,
wherein the receiver receives the identification information from the portable display apparatus when the portable display apparatus is placed at a position upon the board, and
wherein the acquisition unit acquires from the storage unit the information being related to both the position and the identification information which is received from the portable display apparatus.

9. The communication apparatus according claim 8,
wherein the acquisition unit acquires from the storage unit the information which relates to both the date corresponding of the position and the identification information being received from the portable display apparatus.

10. The communication apparatus according claim 7:
wherein the information stored in the storage is graphic information.

11. The communication apparatus according claim 7,
wherein when the receiver receives two or more the identification information and at least one of the portable display apparatus detects to connect with another portable display apparatuses, the acquisition unit acquires from the storage unit the information related to both of the identification information which are received from the portable display apparatus,
wherein the acquisition unit divides the information which acquired from the storage unit, and
wherein the transmitter transmits each the divided information to each the portable display apparatuses which transmitted the identification information.

12. Communication method for communicating with a storage unit and portable display apparatus for displaying information, the communication apparatus comprising:
receiving an identification information from the portable display apparatus when the portable display apparatus is placed upon the board;
acquiring from the storage unit the information related to the identification information which is received from the portable display apparatus; and
transmitting to the portable display apparatus the information which is acquired by the acquisition unit.
